(19) United States
(12) Patent Application Publication
(10) Pub. No.: US 2003/0149705 A1
(43) Pub. Date: Aug. 7, 2003

(54) Apparatus and user method for registering user information

(76) Inventor: Yoshito Kogure, Tokyo (JP)

Correspondence Address: FROMMER LAWRENCE & HAUG LLP, 745 FIFTH AVENUE, NEW YORK, NY, 10151, US

(21) Appl. No.: 10/356,137

(22) Filed: Feb. 3, 2003

(30) Foreign Application Priority Data
Feb. 5, 2002 (JP) P2002-027641

(51) Int. Cl. G06F 7/00; G06F 17/00

(52) U.S. Cl. 707/102

(57) ABSTRACT

User's basic information such as an address and a name are pre-stored to a storing device with an input device. In addition to selection items, basic information about a user who tends to select the selection items is stored as meta data to a database. When information such as hobbies and favorites of the user is selected from selection items and registered, a processing device filters the selection items using the user's basic information stored in the storing device and the meta data stored in the database. The selection items are displayed on the output device the first time. As a result, the user can easily select his or her desired selection item from many selection items.

### BACKGROUND OF THE INVENTION

1. Field of the Invention

The present invention relates to apparatus and method for registering user information, in particular, to those with which a user can suitably register his or her personal information.

2. Description of the Related Art

As a digital television broadcast receiving apparatus, a storage type receiving apparatus which has a large storing device has been proposed. The storage type receiving apparatus selectively stores programs corresponding to user's hobbies and favorites and allows the user to reproduce the stored programs. To receive and store programs, it is necessary to pre-register information about user's hobbies and favorites.

In a user information registering system which the user uses to register his or her personal information, when the system asks him or her to register his or her hobbies and favorites, the system presents categorized selection items to him or her and asks him or her to select some therefrom. For example, when the user registers information about his or her favorites of music, the system presents selection items of music genres to him or her. The user selects his or her favorite music genre from the presented selection items. Next, the system presents selection items for artists of the selected music genre to the user. The user selects his or her favorite artist from the presented selection items. The system registers the selected artist as information about user's favorite artist.

However, the conventional user information registering apparatus has the following problem. For example, when the user registers information about his or her favorite artist, his or her favorite artists are steadily increased. However, selection items of old artists cannot be deleted. As a result, the user should select his or her favorite artist from so many selection items for artists.

In other words, besides the case that information about favorites of music is registered, when the user is asked to select one from many selection items, he or she should perform a very troublesome work to search so many selection items for his or her desired item.

When for example a display device displays so many selection items on one screen, the size of the characters of the selection items becomes small. Thus, it becomes difficult for the user to recognize the contents of the selection items. Consequently, it is necessary to display selection items on a plurality of screens. However, when the selection items are displayed on a plurality of screens, the user should reference too many screens and search them for his or her favorite selection. Thus, the user should perform such a very troublesome operation.

In contrast, when selection items are too small especially in a tree structure, since the selection items are displayed on a plurality of screens, the user should reference many screens. Thus, since the user should reference many screens, he or she should unnecessarily change the screens. As a result, it is also very difficult for the user to search them for his or her favorite selection item.

### OBJECTS AND SUMMARY OF THE INVENTION

Therefore, an object of the present invention is to provide apparatus and method for registering user information, they allowing user information to be easily registered.

To accomplish the forgoing object, the present invention is a user information registering apparatus for registering information about a user, the apparatus comprising:

inputting means for inputting first information such as a name and an address of the user and second information such as hobbies and favorites of the user;

storing means for storing the first information and the second information which have been input from the inputting means;

a database for storing selection items and the first information about the user who tends to select the selection items as meta data;

selecting means for filtering selection items stored in the database using the first information stored in the storing means and the meta data and selecting filtered selection items as information of user's selection items; and

outputting means for outputting information about the user's selection items,

wherein the second information is selected from the selection items presented by the outputting means.

In the user information registering apparatus according to the present invention, storing means stores first information. Selecting means filters selection items of a database using stored first information and meta data stored in the database. The filtered selection items are presented as selection candidates. Thus, since the user does not need to reference all selection items, he or she can easily select his or her desired selection item.

These and other objects, features and advantages of the present invention will become more apparent in light of the following detailed description of a best mode embodiment thereof, as illustrated in the accompanying drawings.

### BRIEF DESCRIPTION OF THE DRAWINGS

FIG. 1 is a schematic diagram showing an example of a user information registering apparatus according to an embodiment of the present invention;

FIG. 2 is a schematic diagram showing an example of user's basic information;

FIG. 3 is a schematic diagram showing an example of information about user's hobbies and favorites;

FIG. 4 is a schematic diagram showing an example of information about an output device;

FIG. 5 is a schematic diagram showing an example of a database according to the embodiment of the present invention;

FIG. 6 is a schematic diagram showing an example of selection items for categories according to the embodiment of the present invention; and

FIG. 7 is a schematic diagram showing an example of displayed selection items according to the embodiment of the present invention.

### DETAILED DESCRIPTION OF THE PREFERRED EMBODIMENT

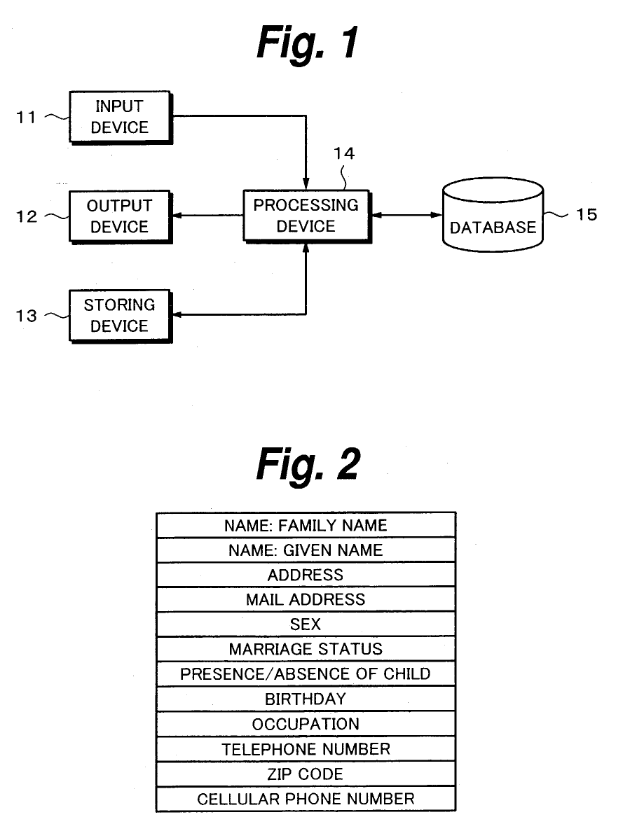

Next, with reference to the accompanying drawings, an embodiment of the present invention will be described. FIG. 1 is a block diagram showing a user information registering apparatus according to the embodiment of the present invention. The user information registering apparatus is disposed in association with for example a digital television broadcast storage type receiving apparatus. In the user information registering apparatus according to the embodiment of the present invention, “name”, “address”, and so forth of the user are referred to as basic information. Information about user's hobbies and favorites is referred to as extension information.

The user information registering apparatus according to the embodiment of the present invention comprises an input device 11, an output device 12, a storing device 13, a processing device 14, and a database 15.

The input device 11 is a device which inputs information to the processing device 14. For example, the input device 11 is composed of a keyboard, a remote controller, and so forth. The input device 11 inputs user's basic information and selection information selected from selection items to the processing device 14. The user's basic information and the selection information will be described later.

The output device 12 is a device which outputs output information of the processing device 14. For example, the output device 12 is composed of a display device. The output device 12 displays items for basic information which the user should input, input fields, and selection items which the user selects, and so forth.

The storing device 13 is a device which registers information which is input by the input device 11. For example, the storing device 13 is composed of a RAM (Random Access Memory), an optical recording medium, and so forth. According to the embodiment of the present invention, the storing device 13 stores not only information which is input by the input device 11, but information about the output device 12.

FIGS. 2 to 4 show examples of information stored in the storing device 13. Basic information is input by the input device 11. The input information is stored in the storing device 13 as shown in FIG. 2. The basic information shown in FIG. 2 is composed of items “name: family name”, “name: given name”, “address”, and so forth. The processing device 14 and the output device 12 ask the user to input these items. When the user has input them with the input device 11, the processing device 14 causes the storing device 13 to store them.

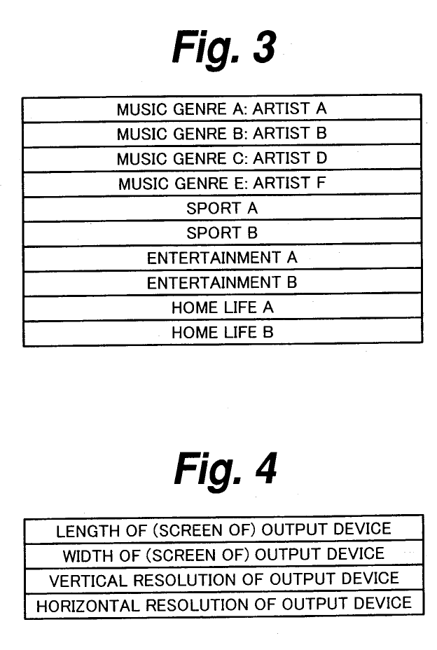

FIG. 3 shows an example of extension information for example information about user's hobbies and favorites stored in the storing device 13. The information about the user's hobbies and favorites is composed of items “music genre A: artist A”, “music genre A: artist B”, . . . , “sport A”, “sport B”, and so forth. Music genres “music genre A: artist A”, “music genre C: artist D” are for example some genres such as classic and jazz. Artists A, B, and so forth are artist names such as performer names and singer names. Sports A, B, and so forth are some genres of sports for example baseball and succor. Entertainments A, B, and so forth are genres for example dramas and comic stories. Home life A, B, and so forth are some genres for example cooking and baby cares.

Information about user's hobbies and favorites is an item which the user has selected from all genre selection items stored in the database 15. Thus, hobby and favorite items are registered as information about user's hobbies and favorites. According to the embodiment of the present invention, artists are also selected from music genres because artists are important as registration items.

FIG. 4 shows an example of information about the output device 12. The information about the output device 12 is composed of items about the output device 12 such as “length of (screen of) output device”, “width of (screen of) output device”, and so forth. Since the information about the output device 12 depends thereon, it is assumed that before user's information is registered, the information about the output device 12 has been registered in the storing device 13.

The storing device 13 stores the user's basic information, the use's extension information, and the information about the output device 12.

The processing device 14 causes the output device 12 to display input fields of items for the basic information which the user should input. The processing device 14 causes the storing device 13 to store the user's basic information which is input from the input device 11. The processing device 14 compares the user's basic information stored in the storing device 13 with meta data of categories or selection items stored in the database 15 and selects categories or selection items which the user tends to select. The meta data will be described later.

Information about the selected categories or selection items which the user tends to select is displayed as user's selected items on the output device 12. At that point, the processing device 14 references the information about the output device 12 stored in the storing device 13. When there are many user's selected items which are displayed, for example, the processing device 14 divides them so that they are displayed on a plurality of screens. In addition, the processing device 14 causes the storing device 13 to store selection information which has been selected from selection items and which has been input from the input device 11 as extension information.

The database 15 stores all selection items. The selection items stored in the database 15 contain meta data with keys of user's basic information stored in the storing device 13. With the basic information which the user has input and the meta data of selection items stored in the database 15, selection items which the user tends to select are selected.

As meta data of each selection item, the basic information of the user who tends to select each selection item has been stored. In this case, it is preferred to filter selection items which the user tends to select in consideration of “address”, “sex”, “marriage status”, “presence/absence of child”, “birthday”, and “occupation” which represent the characteristics of the user as the user's basic information shown in FIG. 2.

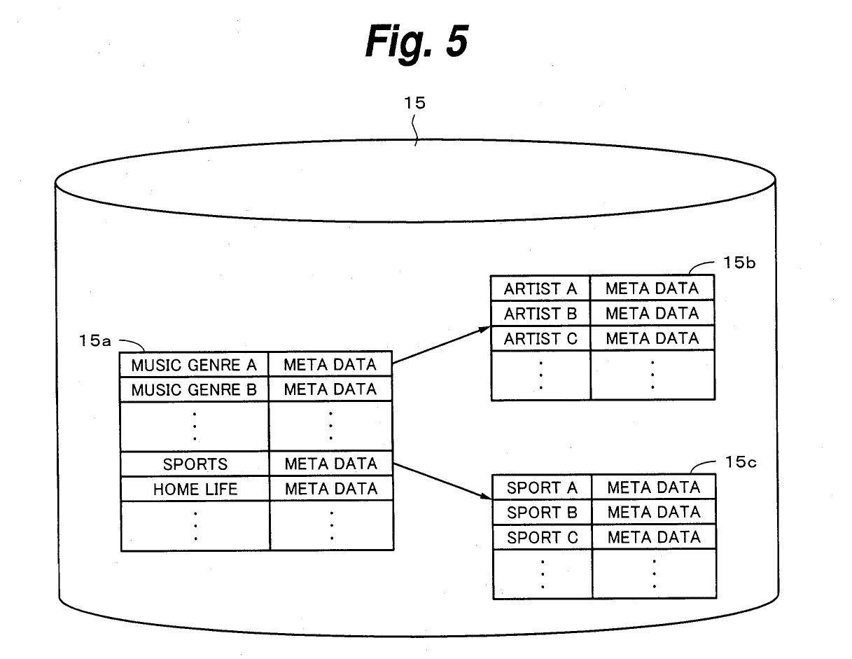

Each selection item stored in the database 15 is tree (hierarchically) structured with at least one layer. FIG. 5 is a schematic diagram showing an example of the database 15 composed of two layers. The database 15 shown in FIG. 5 contains a category table 15a composed of category items of hobbies and favorites and meta data. As meta data of the category table 15a, basic information of the user who tends to select each category item has been stored.

The database 15 also contains selection item tables 15b, 15c, and so forth. Each of the selection item tables 15b, 15c, and so forth is composed of selection items of each category and meta data. As meta data of each selection item table, basic information of the user who tends to select each selection item has been stored.

The user information registering apparatus according to the embodiment of the present invention operates in the following manner. First of all, to store user's basic information to the storing device 13, the processing device 14 causes the output device 12 to display input items of basic information. Corresponding to the displayed input items, the user inputs his or her basic information with the input device 11. The input basic information is stored to the storing device 13 through the processing device 14. In such a manner, user's basic information shown in FIG. 2 is registered.

Next, as an example of user's extension information, information about user's hobbies and favorites is stored in the storing device 13. At that point, the processing device 14 compares user's basic information stored in the storing device 13 with meta data of each category of the category table (shown in FIG. 5) stored in the database 15 and selects categories which the user tends to select.

In addition, the processing device 14 reads the information about the output device 12 from the storing device 13. The information about the output device 12 has been stored in the storing device 13. The information about the output device 12 is for example the length and width of the screen of the output device 12, the vertical and horizontal resolutions thereof, and so forth. Corresponding to the information about the output device 12, the processing device 14 calculates an optical number of selection items which are displayed at a time. The selection items which the user tends to select are displayed as user's selection items so that the user can select one therefrom. At that point, when the number of selection items which are displayed is greater than the optimum number of selection items which have been calculated, the processing device 14 divides the selection items for a plurality of screens so that the number of selection items displayed at a time does not exceed the optimum number of selection items.

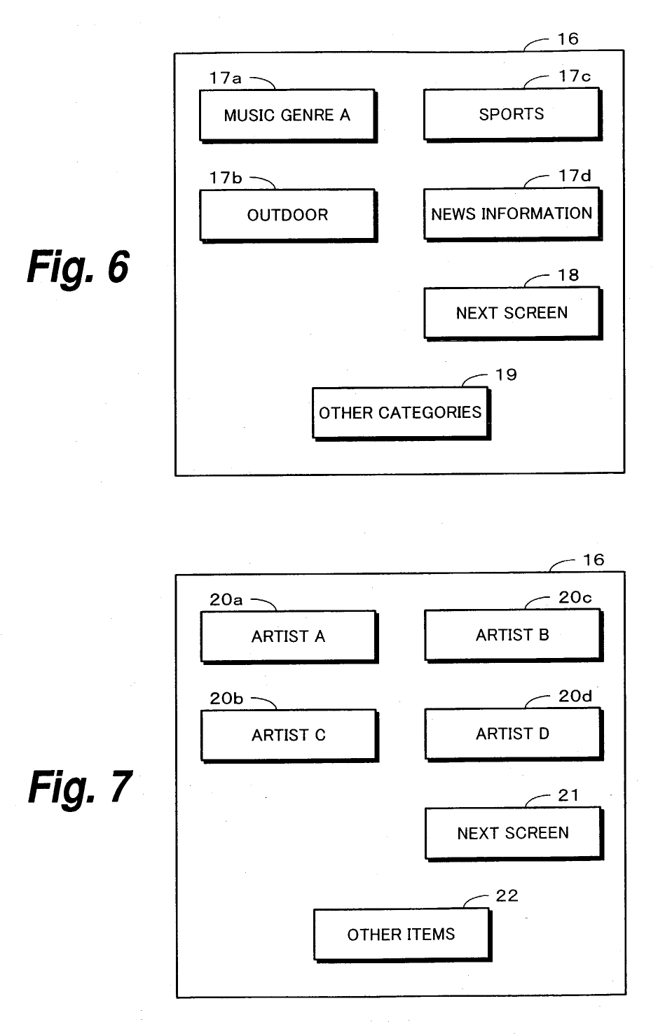

FIG. 6 is a schematic diagram showing an example of a display screen for category selection items. In FIG. 6, a screen 16 is a display screen of the output device 12. Selection icons 17a to 17d are icons which represent category selection items of hobbies and favorites selected as categories which the user tends to select. As was described above, the selection icons 17a to 17d are displayed on the screen 16 so that they do not exceed the optimum number. Thus, since the size of characters of the selection items is not reduced, the user can recognize them without difficulty.

When necessary, screen change icons 18 for example “next screen” and “previous screen” shown in FIG. 6 can be provided. With the screen change icons 18, the current screen can be changed to the next screen or the previous screen. In addition, a functional icon 19 for example “other categories” shown in FIG. 6 can be provided. With the functional icon 19, categories which have not been selected as those which the user tends to select are displayed on the next screen of the output device 12. With these icons, the user can more easily register information.

When the user selects one of the category selection icons (selection icons 17a to 17d shown in FIG. 6) displayed on the output device 12, the processing device 14 compares user's basic information stored in the storing device 13 with meta data of each selection item of the selection item table of the selected category and selects selection items which the user tends to select.

The processing device 14 causes the output device 12 to display the selection items which have been selected as those which the user tends to select so that he or she can select one of them. At that point, when the number of selection items displayed on the output device 12 exceeds the optimum number which has been calculated, the processing device 14 divides the selection items for a plurality of screens so that the number of selection items displayed does not exceed the optimum number.

FIG. 7 shows an example of a screen displayed after the selection icon 17a “music genre A” shown in FIG. 6 has been selected. Selection icons 20a to 20d are icons of selection items selected as those which the user tends to select in the category “music genre A”. As was described above, the selection icons 20a to 20d are displayed so that they do not exceed the optimum number. Thus, since the size of characters of the selection items is not reduced, the user can recognize the contents of the selection items without difficulty.

When necessary, screen change icons 21 for example “next screen” and “previous screen” shown in FIG. 7 can be provided. With the screen change icons 21, the current screen can be changed to the next screen or the previous screen. In addition, a functional icon 22 for example “other categories” shown in FIG. 7 can be provided. With the functional icon 22, categories which have not been selected as those which the user tends to select are displayed on the next screen of the output device 12. With these icons, the user can more easily register information.

When the user selects one of the selection items (selection icons 20a to 20d shown in FIG. 7) displayed on the output device 12, the processing device 14 stores information of the selection item as information about use's hobbies and favorites to the storing device 13. As a result, information about user's hobbies and favorites as an example of user's extension information is registered.

As was described above, in the user information registering apparatus according to the embodiment of the present invention, when the user tries to select a category of hobbies and favorites to register information about hobbies and favorites as an example of extension information, the processing device 14 compares user's basic information stored in the storing device 13 with meta data of each category stored in the database 15, selects categories which the user tends to select, and presents the selected categories onto the output device 12. As a result, the user can easily search for his or her desired category.

Likewise, after the category of hobbies and favorites has been selected, when the user tries to select his or her desired selection item, the processing device 14 compares user's basic information stored in the storing device 13 with meta data of each selection item stored in the database 15, selects selection items which the user tends to select, and presents the selected selection items onto the screen 16 of the output device 12. As a result, the user can easily search for his or her desired selection item.

Alternatively, information about the output device 12 is pre-registered to the storing device 13. With reference to the information about the output device 12, the optimum number of selection items which are displayed at a time may be calculated. When the number of categories or the number of selection items which have been selected is greater than the calculated optimum number, they are divided for a plurality of screens. The divided categories or selection items are displayed on the screen 16 of the output device 12. As a result, the user can easily recognize the contents of the categories and selection items.

Thus, when the user selects his or her desired selection item from many selection items, selection items corresponding to the user are displayed the first time. Thus, the user can easily select his or her desired selection item. In addition, since only selection items corresponding to the size of the output device are displayed at a time. Consequently, it is not necessary to reduce the size of characters of the selection items. In addition, when selection items are tree structured or when the number of selection items which are displayed one each screen is too small, the user does not need to unnecessarily change the screens.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention. For example, according to the embodiment of the present invention, examples of the input device 11 are a keyboard and a remote controller. However, according to the present invention, the input device 11 is not limited to such examples. Information may be input with a touch screen or a sound recognition function of a telephone or the like.

According to the embodiment of the present invention, the database 15 and the storing device 13 are connected to the processing device 14. Alternatively, the database 15 and the storing device 13 may be used in such a manner that they are disconnected from other devices using a communication line.

FIG. 2 shows an example of basic information according to the embodiment of the present invention. In other words, according to the embodiment of the present invention, the items of the basic information are not limited to those of the example. According to the embodiment of the present invention, as the information about the output device 12, the items shown in FIG. 4 are used. As the information about the output device 12, the other items may be used.

In addition, according to the embodiment of the present invention, the database 15 is structured as shown in FIG. 5. However, the database 15 may be structured in a different manner. For example, according to the embodiment of the present invention, the database 15 is tree structured with two layers. Alternatively, the database 15 may be structured with one layer, three layers, four layers, and so forth.

The user information registering apparatus according to the embodiment of the present invention is for example an user information registering apparatus which receives and stores digital television broadcast programs. However, the present invention can be applied for various types of apparatuses, for example an apparatus which registers user information through Internet.

In addition, the storing device 13 according to the embodiment of the present invention stores information about the output device 12. However, when the information is output in fixed sizes such as VGA (Video Graphics Array) or XGA (extended Graphics Array), it is not always necessary to store the information of the output device 12 to the storing device 13. In this case, the optimum number of selection items which are displayed on each output device may be preset. Corresponding to the size of the output device, the optimum number may be changed.

As was described above, according to the embodiment of the present invention, when user selects information about hobbies, favorites, and so forth, selection items which the user tends to select are presented as selection candidates. Thus, the user does not need to select his or her desired selection item from all the selection items. As a result, the user can easily select his or her desired selection item. Thus, the user can easily register information.

What is claimed is:

1. A user information registering apparatus for registering information about a user, the apparatus comprising:
inputting means for inputting first information such as a name and an address of the user and second information such as hobbies and favorites of the user;
storing means for storing the first information and the second information which have been input from the inputting means;
a database for storing selection items and the first information about the user who tends to select the selection items as meta data;
selecting means for filtering selection items stored in the database using the first information stored in the storing means and the meta data and selecting filtered selection items as information of user's selection items; and
outputting means for outputting information about the user's selection items,
wherein the second information is selected from the selection items presented by the outputting means.

2. The user information registering apparatus as set forth in claim 1,
wherein the storing means is configured to store information about the outputting means, determine an optimum number of selection items presented by the outputting means at a time, and cause the outputting means to present selection items which are smaller than the optimum number to the user.

3. The user information registering apparatus as set forth in claim 2,
wherein when the number of selection items which have been selected is greater than the optimum number, the selection items are divided for a plurality of screens and presented by the outputting means.

4. The user information registering apparatus as set forth in claim 1,
wherein the database can be controlled through a communication.

5. A user information registering method for registering information about a user, the method comprising the steps of:
inputting first information such as a name and an address of the user and second information such as hobbies and favorites of the user;
storing the first information and the second information which have been input at the inputting step;
providing a database for storing selection items and the first information about the user who tends to select the selection items as meta data;
filtering selection items stored in the database using the first information stored at the storing step and the meta data and selecting filtered selection items as information of user's selection items; and
outputting information about the user's selection items,
wherein the second information is selected from the selection items presented at the outputting step.
